(19) United States
(12) Patent Application Publication
(10) Pub. No.: US 2010/0101427 A1
(43) Pub. Date: Apr. 29, 2010

(54) CONTROLLING A LIQUID FLOW THROUGH HEATER

(75) Inventor: Bernardo Arnoldus Mulder, Drachten (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/526,643

(22) PCT Filed: Feb. 11, 2008
(86) PCT No.: PCT/IB08/50479

§ 371 Date: Aug. 11, 2009

(30) Foreign Application Priority Data
Feb. 16, 2007 (EP) 07102580.3

(51) Int. Cl. A47J 31/44; G05D 7/06; G05D 23/19

(52) U.S. Cl. 99/282; 700/282; 99/300; 700/300

(57) ABSTRACT

A liquid flow through heater for heating a liquid (10) comprises a channel (4) and an electric heater element (50) for heating at least a portion of the channel (4). A temperature sense unit (6, 60) senses a temperature (ST1; ST1, ST2) indicative of the temperature of the liquid. A flow control means (3) controls a flow of the liquid (10) through the channel (4). A controller (7) controls in a first phase (PH1), (i) the electric heater element (50) to pre-heat at least the portion of the channel (4), and (ii) the flow control means (3) to obtain a rate of flow of the liquid (10) through the channel (4) which is zero or relatively small with respect to a rate of flow during a second and/or third phase. The controller (7) controls in the second phase (PH2) succeeding the first phase (PH1), (i) the electric heater element (50) to supply a predetermined heating power independent on the sensed temperature (ST1; ST1, ST2), and (ii) the flow control means (3) to obtain a flow of the liquid (10) through the channel (4), and in the third phase (PH3) succeeding the second phase (PH2), (i) the electric heater element (50) to supply a heating power (HP) in dependence on the sensed temperature (ST1; ST1, ST2) to substantially stabilize the sensed temperature (ST1; ST1, ST2) on a desired target value (TV), and (ii) the flow control means (3) to obtain a flow of the liquid (10) through the channel (4).

### FIELD OF THE INVENTION

The invention relates to a liquid flow through heater for heating a liquid flowing through a channel, and a beverage brewing machine comprising such a liquid flow through heater.

### BACKGROUND OF THE INVENTION

US2002/0051632A1 discloses a water flow heater with a first heater element for supplying a fixed power and a second controllable heater element. A temperature sensor senses the temperature of the heated water. A control unit controls the heat supply from the second heater element in dependence on a temperature detected by the temperature sensor. A pump generates a water flow-rate lying within a predetermined range through the channel. In an embodiment, when heated water is desired, first a preheating phase occurs wherein the control unit switches on both heater elements. After the desired preheating period, the pump is activated and the water starts flowing through the heater elements. During this phase a closed loop feedback is used: the control unit reacts on a sensed temperature change by controlling the power supplied to the second heater element to counteract the temperature change.

Although, a closed loop feedback is present to control the power supplied to the second heater element in dependence on the sensed temperature, this prior art water flow heater has the drawback that the temperature of the water supplied is not sufficiently constant.

### SUMMARY OF THE INVENTION

It is an object of the invention to provide a liquid flow heater which supplies the liquid having a more constant temperature.

A first aspect of the invention provides a liquid flow heater as claimed in claim 1. A second aspect of the invention provides a beverage brewing machine as claimed in claim 7. Advantageous embodiments are defined in the dependent claims.

A liquid flow heater for heating a liquid in accordance with the first aspect of the invention comprises a channel through which the liquid to be heated flows when the heated liquid should be supplied. An electric heater element heats at least a portion of the channel. Such a combination of the heater element and the channel is often referred to as a flow through heater. A temperature sensor senses a temperature of a wall of the channel, or of a wall of the electric heater element, or of the liquid when in the channel. A flow control device or unit controls a flow of the liquid through the channel. For example, the flow control device may be pump which, when activated, pumps the liquid through the channel. Alternatively, water from a water reservoir may flow through the channel under influence of gravity, and the flow control device is a valve in, or in series with, the channel.

A controller controls the electric heater element and the flow control device in at least the three following consecutive phases in the order mentioned.

In a first phase, also referred to as the preheating phase, the controller controls the electric heater element to pre-heat at least the portion of the channel. The controller controls the flow control device to obtain a relatively small rate of flow of liquid through the channel. This has the advantage that it possible to sense the temperature of the liquid itself without requiring an expensive wall temperature sensor. Further, this enables to sense the temperature of the liquid at the outlet of the channel. The rate of flow during the first phase is relatively small with respect to the rate of flow during the second and third phase to prevent that a large amount of liquid is supplied with a too low temperature. For example, a ratio of the flow during the first phase and the flow during the second and/or third phase may be in the range from 1 to 4 to 1 to 25.

In a second phase, further also referred to as the open loop phase, the controller controls the flow control device to obtain a start of the flow of the liquid through the channel. For example, the pump is activated or the valve is opened. If the channel already contained liquid, this liquid has already a high temperature. If no liquid was in the channel, the liquid entering will be heated rapidly because of the preheated heater and channel walls. Now, the liquid is flowing through the channel and the controller controls the electric heater element to supply a predetermined heating power independent on the sensed temperature but has a predetermined value or changes according to a predetermined curve or series of values. Thus, the heating power is not controlled using a closed loop feedback.

For example, the electric heater element may supply a heating power equal to the maximum heating power. Alternatively, the heater element may supply a heating power which is equal to approximately a steady state heating power, or which changes from the maximum heating power into approximately the steady state heating power. The steady state heating power is the heating power required at the end of the third phase during which the system is operating in the closed loop feedback mode.

In the third phase which succeeds the second phase and which is further also referred to as the closed loop phase, the controller controls the electric heater element to supply a heating power in dependence on the sensed temperature to substantially stabilize the temperature on a desired target value. The controller controls the flow control device to obtain a flow of the liquid through the channel by either activating the pump or by opening the valve.

The introduction of the open loop phase in between the preheating phase and the closed loop phase has the advantage that the overshoot and undershoot in the temperature of the liquid leaving the channel is decreased. In the prior art the closed loop phase is activated immediately after the preheating phase. Because the closed loop control system has no knowledge of the characteristics causing the overshoot and undershoot, the closed loop is not able to minimize them. In accordance with the present invention, the designer of the system is aware of these characteristics and is able to design or determine an optimal heating power curve or level(s) to minimize the overshoot and undershoot. Consequently, by adding the open loop phase in which a predetermined heating power is supplied it is possible to supply the liquid with a more constant temperature than in the prior art.

In an embodiment, the controller controls the flow control device to prevent the liquid to flow through the channel. Thus, if no liquid is in the channel, the liquid is prevented to enter the channel, or when the liquid is present in the channel, the liquid is prevented to flow through the channel. In both situations, the pump is inactive or the valve is closed. The electrical heater may supply any predetermined heating power. The higher the heating power is, the shorter the preheating phase will be. Thus, preferably, the heater supplies the maximum heating power. To prevent a too sudden heavy load on the mains, the heating power may gradually increase during the preheating phase.

In an embodiment, the temperature sense unit comprises a temperature sensor for obtaining a sensed temperature of a wall of the channel, or a sensed temperature of a wall of the electric heater element, or a sensed temperature of the liquid when in the channel.

In an embodiment, the controller detects during the first phase when the sensed temperature rises above a predetermined value, and starts the second phase if so. During the third phase the controller stabilizes the sensed temperature. In this embodiment, the same sensed temperature is used both for starting the second phase and for stabilizing this temperature with the closed loop during the third phase. Only one sensor is required. Alternatively, the second phase may be started a predetermined period of time after the start of the first phase.

In an embodiment, the temperature sense unit comprises a first temperature sensor to sense a first sensed temperature and a second temperature sensor to sense a second sensed temperature. The first and the second sensed temperatures being different ones of the sensed temperature of the wall of the channel, or the sensed temperature of the wall of the electric heater element, or the sensed temperature of the liquid when in the channel. The use of more than one sensor may improve the temperature behavior of the system. However, a drawback is that two sensors are required.

In an embodiment, the controller detects during the first phase when the first sensed temperature rises above a predetermined value, and starts the second phase at this instant. The controller stabilizes the second sensed temperature during the third phase. This approach has the advantage that different temperatures can be used to start the second phase and to provide a control input variable for the closed loop during the third phase. For example, the first sensed temperature is the sensed temperature of the wall of the channel, preferably near to the heater, or the temperature of the wall of the heater, and the second sensed temperature is the sensed temperature of the liquid.

In an embodiment, a fourth phase succeeding the third phase has been added wherein the controller deactivates the electric heater element such that no heating power is supplied anymore. Further, the controller controls the flow control device to maintain the flow of the liquid through the channel. This has the advantage that the system is cooled down sufficiently to prevent any steam generation.

The liquid flow through heater can be used in, for example, a beverage brewing machine to heat water to be pressed or flowing through, for example, a coffee, thee or chocolate pad. The heater may also be used to heat milk, for example in preparing a hot chocolate drink. The heated milk may be added to the coffee or thee, or may be consumed as such. Especially if the milk (or other liquid based drink or food) is given to a baby or impaired people a good control of the temperature of the milk is essential. The heater may also be used for making steam which for example is used for frothing milk. The heater is not limited to beverage brewing machines operating with a pad. Instead of the pad a refillable holder may be present to hold grinded coffee or thee. The heater may be used in systems in which the water is pressed through the channel such as in an espresso machine, but may also be used in systems in which the water flows through the channel under gravity force only.

These and other aspects of the invention are apparent from and will be elucidated with reference to the embodiments described hereinafter.

### BRIEF DESCRIPTION OF THE DRAWINGS

In the drawings:

FIG. 1 shows schematically an embodiment of a beverage brewing machine with a flow through heater,

FIGS. 2A to 2C show schematically waveforms to elucidate the known operation of a prior art water flow heater, and FIGS. 3A to 3C show schematically waveforms occurring in an embodiment of the beverage brewing machine in accordance with the present invention.

It should be noted that items which have the same reference numbers in different Figures, have the same structural features and the same functions, or are the same signals. Where the function and/or structure of such an item has been explained, there is no necessity for repeated explanation thereof in the detailed description.

### DETAILED DESCRIPTION

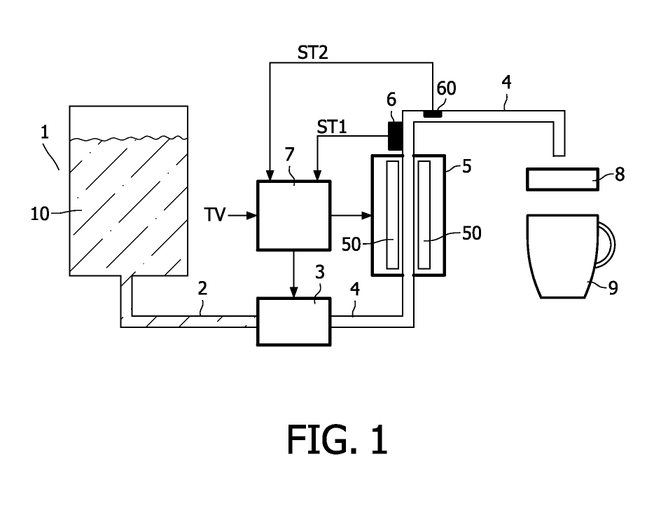

FIG. 1 shows schematically an embodiment of a beverage brewing machine with a flow through heater. The beverage brewing machine comprises a water reservoir 1 in which the liquid 10 to be heated is stored. Usually, in beverage brewing machines this liquid is water, but alternatively, the liquid may be milk.

In the embodiment shown in FIG. 1, a pump 3 pumps the water 10 from the water reservoir 1 into a cup 9. The water 10 enters the pump 3 via a channel or conduit 2 and is supplied by the pump to the channel 4. The pump 3 pumps the water through the channel 4 via a consumable pad 8 into the cup 9. Alternatively, instead of the pump 3 a valve may be used if the lowest level of the water 10 in the water reservoir 1 is higher than the highest fill level in the cup 9, such that the water 10 can fall from the reservoir 1 into the cup 9 without the need for a pump 3. For example, the consumable pad 8 may contain coffee or thee. Instead of the consumable pad 8 a user refillable holder for receiving grinded coffee or tea leaves may be present. Alternatively, the setup shown may be used to brew filter coffee. Although the pad 8 is shown to be placed in an open system such that the hot water has to fall through the pad by gravity, the system may be closed and the hot water may be applied under pressure to the pad 8 such as is usual in Philips Senseo machines or in espresso brewing machines.

An electrical heater 5 has heater elements 50 which are arranged along the channel 4 to heat the channel 4 and the water 10 in the channel 4 when present. The portion of the channel 4 which is heated by the heater elements 50 may extend substantially vertical to improve the convection. The heater elements may comprise resistive wires which are heated by a current flowing there through. Although a single heater element 50 is shown, alternatively several heater elements may be arranged in parallel or in series. The controllable electrical power can be supplied to all the heater elements or only to a subset of the heater elements.

A sensor 6 is arranged near the channel 4 to sense the wall temperature of the channel 4 downstream the heater 5. Alternatively, the sensor 6 may be arranged inside the channel 4 to sense the water temperature of the water 10 leaving the heater 5, or the sensor 6 may sense the wall temperature of a wall of the heater 5. For example, this wall of the heater 5 may be a wall of the heater element 50. Optionally, a further temperature sensor 60 may be present which for example senses the temperature of the water 10 upstream of the heater 5.

The controller 7 has an input to receive the sensed temperature ST1 sensed by the temperature sensor 6 and optionally a further input to receive the sensed temperature ST2 sensed by the temperature sensor 60. The controller 7 may use the different sensed temperatures ST1 and ST2 to obtain an optimal temperature profile of the water by controlling different issues with different temperatures, as will be elucidated later. Alternatively, the controller 7 may use the temperature difference between the temperatures sensed by the two temperature sensors 6 and 60. The controller 7 has outputs to supply control signals to the heater 5 and the pump 3.

The heater 5 can be controlled by controlling a level of a voltage applied to, or a level of a current flowing through, the heater elements 50. The control may be continuously or time discrete. Usually, although not essential, the heater elements are connected to the mains voltage (not shown) via an electronic switching device (not shown). The control signal supplied by the controller 7 may control the on-off duty cycle of the electronic switching device to control the average electrical power supplied to the heater elements 50. Consequently, also the heating power HP supplied by the heater elements 50 is controlled.

The pump 3 can be switched on and off. Alternatively, also the water flow through the pump 3 can be controlled by the controller 7 to even further decrease the temperature fluctuations of the heated water. If instead of the pump 3, a valve can be used, the valve is switched on or off to pass the water 10 or to block the water 10, respectively.

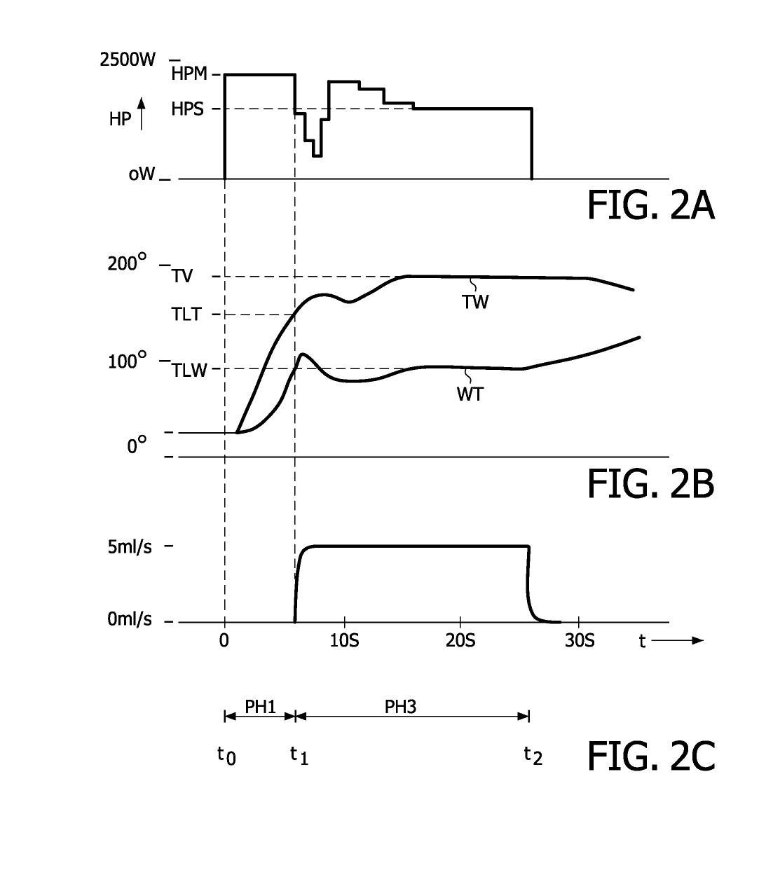

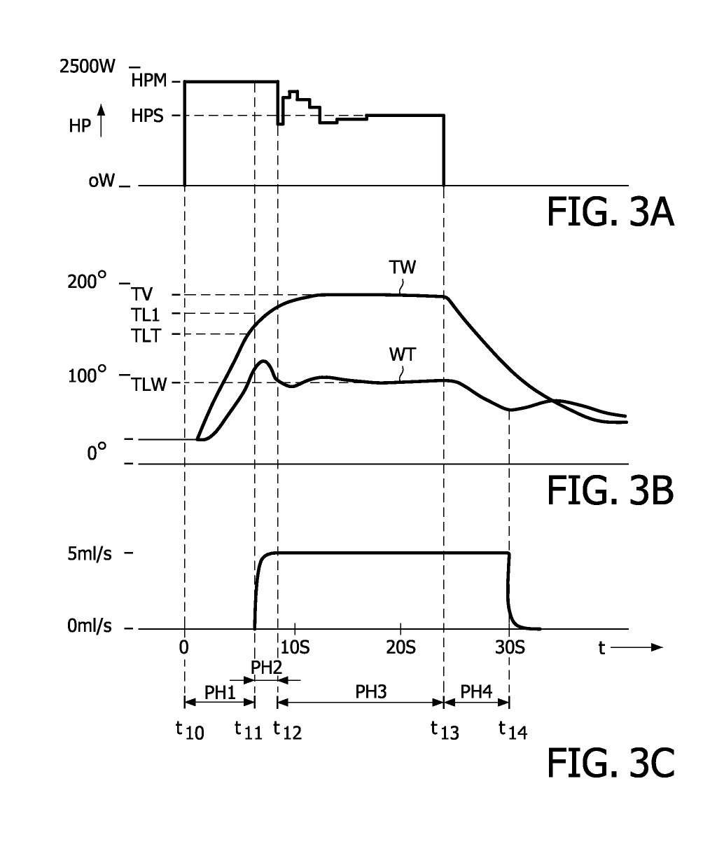

The system shown in FIG. 1 is used to elucidate with respect to the waveforms shown in FIGS. 2A to 2C the known operation of the brewing machine, and to elucidate with respect to the waveforms shown in FIGS. 3A to 3C an embodiment in accordance with the present invention. The waveforms shown in FIGS. 2 and 3 occur in a system in which the temperature sensor 6 senses the water temperature. Similar waveforms occur if the temperature sensor 6 senses the wall temperature of the channel 4 inside or downstream outside the heater 5. The waveforms may deviate more if the temperature of a wall of the heater 5 is sensed.

Alternatively, in an embodiment, when the two temperature sensors are present. One of the temperature sensors senses the wall temperature, while the other one senses the water temperature. The temperature sensor which senses the wall temperature is used to switch on the pump and to activate the closed loop, while the temperature sensor which senses the water temperature is used to control the temperature of the water during the closed loop phase.

FIGS. 2A to 2C show schematically waveforms for elucidating the known operation of a prior art water flow heater. FIG. 2A shows the heating power HP in Watts supplied by the heater 5. FIG. 2B shows both the wall temperature TW in degrees Celsius of the channel 4 within the heater 5, and the water temperature WT in degrees Celsius of the water leaving the channel 4 at the position of the temperature sensor 6. FIG. 2C shows the flow rate of the water 10 through the channel 4 in ml per second. All time periods, powers, temperatures and flow rates are examples only.

At the instant t0, the preheating phase PH1 starts and the controller 7 controls the heater 5 to supply the maximum heating power HPM. Both the wall temperature indicated by the graph TW and the sensed water temperature indicated by the graph WT start increasing. It the instant t1 the water temperature WT has reached the set point temperature or desired steady state level TLW and the preheating phase PH1 ends. At this instant t1, the wall temperature TW is equal to TLT. If the sensor 6 is present it is possible to sense the wall temperature and no flow of liquid is required to sense the temperature at or near the heater position. Alternatively, for example if only the sensor 60 is present, during the first phase a relatively small rate of flow of the liquid is applied to be able to sense the temperature of the liquid.

At the instant t1, the controller 7 activates the pump 3 and the water 10 starts flowing through the channel 4, see FIG. 2C. Further, at the instant t1, the control loop is closed and the controller 7 starts controlling the heater 5 to supply a heating power HP dependent on the sensed temperature ST. The start value of the closed loop is the steady state heating power HPS. As is clear from FIG. 2B, the controller 7 starts operating in the closed loop mode when the water temperature WT is above the set point temperature TLW. Consequently, in reaction the controller 7 decreases the heating power HP. However, due to inherent time delays caused by time constants in the system and the integrating action of the closed loop, it takes some time until the temperature WT reaches the set point temperature TLW again. Now the heating power HP increases again to counteract for the too low temperature WT. But as shown in FIG. 2B, the water temperature WT lies below the set point temperature TLW during quite a long period of time. In the end the water temperature stabilizes at the set point temperature TLW. The closed loop phase PH3 lasts from the instant t1 to the instant t2.

It has to be noted that the water temperature may show an overshoot because at the instant t1 when the pump starts, the water at the entrance portion of the flow through heater has already the same high temperature as the rest of the water in the flow through heater but will be additionally heated when flowing through the flow through heater towards its outlet.

At the instant t2, the controller 7 switches off the heater 5 and the pump 3 and the water flow stops. The wall temperature TW of the heater 5 starts decreasing and the water temperature WT starts increasing because of the still high wall temperature TW.

FIGS. 3A to 3C show schematically waveforms occurring in an embodiment of the beverage brewing machine in accordance with the present invention. FIG. 3A shows the heating power HP supplied by the heater 5 in Watts. FIG. 3B shows both the wall temperature TW of the channel 4 at the position where the temperature sensor 6 is arranged in degrees Celsius, and the water temperature WT of the water leaving the channel 4 in degrees Celsius. FIG. 3C shows the flow rate of the water 10 through the channel 4 in ml per second. All time periods, powers, temperatures and flow rates are examples only.

At the instant t10, the known preheating phase PH1 starts and the controller 7 controls the heater 5 to supply the maximum heating power HPM. Both the wall temperature indicated by the graph TW and the sensed water temperature indicated by the graph WT start increasing. It the instant t11 the water temperature WT has reached the set point temperature or desired steady state level TLW and the preheating phase PH1 ends. At the instant t11, the wall temperature TW is equal to TLT.

At the instant t11, at which the open loop phase PH2 starts, the controller 7 activates the pump 3 and the water 10 starts flowing through the channel 4, see FIG. 2C. Further, at the instant t11 the controller 7 controls the heater 5 to supply the maximum heating power HPM. Alternatively, during the open loop phase PH2, the controller 7 may control the heater 5 to supply the steady state heating power HPS, or any other suitable power level, sequence of power levels, or a continuously changing heating power HP. The open loop phase PH2 ends at the instant t12 at which the known closed loop phase PH3 starts. The instant t12 is determined by the water temperature WT dropping below the set point temperature TLW.

At the instant t12, the known closed loop phase PH3 starts. The controller 7 keeps the pump 3 activated and the water 10 keeps flowing through the channel 4. Further, at the instant t12, the control loop is closed and the controller 7 starts controlling the heater 5 to supply a heating power HP dependent on the sensed temperature ST. The start value of the closed loop is preferably the steady state heating power HPS. As is clear from FIG. 3B, immediately after the start of the closed loop mode the water temperature WT is below the set point temperature TLW. Consequently, the controller 7 increases the heating power HP. However, due to inherent time delays caused by time constants in the system and an integrating action of the closed loop, it takes some time until the temperature WT crosses the set point temperature TLW. Now the heating power HP decreases to counteract for the too high water temperature WT. As shown in FIG. 3B, the water temperature WT now lies below the set point temperature TLW during a relatively short period of time only. Thus, the comparison of the water temperature curve WT shown in FIG. 3B with that of FIG. 2B shows that the water temperature WT at the start of the brewing operation has become more constant. In the end the water temperature stabilizes at the set point temperature TLW. The closed loop phase PH3 lasts from the instant t12 to the instant t13.

Optionally, at the instant t13, the controller 7 switches off the heater 5 but keeps the pump 3 active. In this manner the heater 5 and the channel 4 are cooled down rapidly to prevent generation of steam. This cooling phase is well defined such that it is possible to compensate during the heating phase such that the correct average temperature of the liquid is obtained.

It should be noted that the above-mentioned embodiments illustrate rather than limit the invention, and that those skilled in the art will be able to design many alternative embodiments without departing from the scope of the appended claims.

For example, a filter may be arranged between the pump 3 and the flow through heater 5. An optional temperature sensor may be arranged to sense the temperature of the liquid 10 leaving the liquid reservoir 1 or of the liquid entering the heater 5. Such an extra temperature sensor enables a feed-forward control compensating for a varying temperature of the liquid 10. The temperature sensor ST2 upstream the flow through heater may be arranged near to the outlet, for example to check whether the liquid temperature is not higher than the desired temperature. It has to be noted that the liquid may be water and that a powder may be mixed with the heated water to obtain a beverage such as hot milk or hot chocolate.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A liquid flow through heater for heating a liquid (10) and comprising:
a channel (4),
an electric heater element (50) for heating at least a portion of the channel (4),
a temperature sense unit (6, 60) for sensing a temperature (ST1; ST1, ST2) indicative of the temperature of the liquid,
a flow control means (3) for controlling a flow of the liquid (10) through the channel (4), and a controller (7) for controlling:
in a first phase (PH1), (i) the electric heater element (50) to pre-heat at least the portion of the channel (4), and (ii) the flow control means (3) to obtain a rate of flow of the liquid (10) through the channel (4) which is smaller than a rate of flow of the liquid (10) through the channel (4) during a second phase (PH2) and/or during a third phase (PH3),
in the second phase (PH2) succeeding the first phase (PH1), (i) the electric heater element (50) to supply a predetermined heating power independent on the sensed temperature (ST1; ST1, ST2), and (ii) the flow control means (3) to obtain a flow of the liquid (10) through the channel (4), and
in the third phase (PH3) succeeding the second phase (PH2), (i) the electric heater element (50) to supply a heating power (HP) in dependence on the sensed temperature (ST1; ST1, ST2) to substantially stabilize the sensed temperature (ST1; ST1, ST2) on a desired target value (TV), and (ii) the flow control means (3) to obtain a flow of the liquid (10) through the channel (4).

2. A liquid flow through heater of claim 1, wherein the flow control means (3) is constructed for in the first phase (PH1) preventing the liquid (10) to flow through the channel (4) when the liquid (10) is present in the channel (4).

3. A liquid flow through heater of claim 1, wherein the temperature sense unit (6, 60) comprises a temperature sensor for obtaining a sensed temperature of a wall of the channel (4), or a sensed temperature of a wall of the electric heater element (50), or a sensed temperature of the liquid (10) when in the channel (4).

4. A liquid flow through heater of claim 3, wherein the controller (7) is constructed for
during the first phase (PH1), detecting when the sensed temperature (ST1; ST1, ST2) rises above a predetermined value,
starting the second phase (PH2) when the sensed temperature (ST1; ST1, ST2) rises above a predetermined value, and
during the third phase (PH3), stabilizing the sensed temperature (ST1; ST1, ST2).

5. A liquid flow through heater of claim 1, wherein the temperature sense unit (6, 60) comprises a first temperature sensor (6) for obtaining a first sensed temperature (ST1) being one of a sensed temperature of a wall of the channel (4), or a sensed temperature of a wall of the electric heater element (50), or a sensed temperature of the liquid (10) when in the channel (4), and a second temperature sensor (60) for obtaining a second sensed temperature (ST2) being another one of the sensed temperature of the wall of the channel (4), or the sensed temperature of the wall of the electric heater element (50), or the sensed temperature of the liquid (10) when in the channel (4).

6. A liquid flow through heater of claim 1, wherein the controller (7) is constructed for
during the first phase (PH1), detecting whether the first sensed temperature (ST1) rises above a predetermined value,
starting the second phase (PH2) when the first sensed temperature (ST1) rises above the predetermined value, and
during the third phase (PH3), stabilizing the second sensed temperature (ST2).

7. A liquid flow through heater of claim 6, wherein the first sensed temperature (ST1) is the sensed temperature of the wall of the channel (4) and the second sensed temperature (ST2) is the sensed temperature of the liquid (10).

8. A liquid flow through heater of claim 1, wherein the controller (7) is constructed for controlling the electric heater element (50) to supply the predetermined heating power during the second phase (PH2), being one of: a maximum heating power (HPM), a steady state heating power (HPS) being a heating power (HP) required at an end of the third phase (PH3) to keep the temperature at the desired target value (TV), or a heating power (HP) changing from substantially the maximum heating power (HPM) to substantially the steady state heating power (HPS).

9. A liquid flow through heater of claim 1, wherein a fourth phase (PH4) succeeding the third phase (PH3) has been added wherein the controller (7) is constructed for controlling (i) the electric heater element (50) to not supply heating power (HP), and (ii) the flow control means (3) to obtain a flow of the liquid (10) through the channel (4).

10. A liquid flow through heater of claim 1, wherein the flow control means (3) is an electrical pump for pumping the liquid (10) through the channel (4).

11. A liquid flow through heater of claim 1, wherein the flow control means (3) are constructed to obtain, when activated during the second or third phase, a substantially constant flow of the liquid (10) through the channel (4).

12. A liquid flow through heater of claim 1, wherein the controller (7) is arranged for during the first phase (PH1) controlling the electric heater element (50) to supply a maximum heating power (HPM), or a heating power increasing to the maximum heating power (HPM).

13. A beverage brewing machine comprising the liquid flow heater of claim 1.

14. A beverage brewing machine as claimed in claim 13 being a coffee and/or thee maker, wherein the liquid is water.
